(19) United States
(12) Patent Application Publication
(10) Pub. No.: US 2014/0315324 A1
(43) Pub. Date: Oct. 23, 2014

(54) DEVICE, METHOD AND APPARATUS FOR THE TRANSFER OF ANALYTES

(71) Applicants: Seyyed Shayan Meysami, Oxford Oxfordshire (GB); Nicole Grobert, Oxford Oxfordshire (GB)

(72) Inventors: Seyyed Shayan Meysami, Oxford Oxfordshire (GB); Nicole Grobert, Oxford Oxfordshire (GB)

(73) Assignee: ISIS INNOVATION LIMITED, Oxford, Oxfordshire (GB)

(21) Appl. No.: 14/241,167

(22) PCT Filed: Aug. 23, 2012
(86) PCT No.: PCT/GB2012/052071

§ 371 Date: Jun. 27, 2014

(30) Foreign Application Priority Data
Aug. 26, 2011 (GB) 1114800.4

(51) Int. Cl. G01N 1/28

(52) U.S. Cl. CPC G01N 1/28
USPC 436/161; 436/173; 422/501

(57) ABSTRACT

According to the present invention, there is provided a device for transferring an analyte from a reaction chamber to a detector, which detector is capable of detecting said analyte. The device comprises a tubular member having a first end adapted to receive a sample containing said analyte within said reaction chamber and a second end adapted to communicate with a sample inlet of said detector; and a jacket for regulating the temperature of sample passing through the tubular member, wherein said jacket is disposed about at least a portion of the tubular member. Methods of using the device, and apparatus comprising the device, are also provided. The device may be used to transfer an analyte from a reaction chamber to a detector during the course of a chemical reaction, such that the reaction can be monitored in situ.

### FIELD OF THE INVENTION

The present invention relates to a device for transferring an analyte from a reaction chamber to a detector. Methods of using the device, and apparatus comprising the device, are also provided. The device may be used to transfer an analyte from a reaction chamber to a detector during the course of a chemical reaction, such that the reaction can be monitored in situ.

### BACKGROUND TO THE INVENTION

For a variety of reasons, it is often desirable to monitor the state of a chemical reaction in situ. Information regarding the state of a chemical reaction can be useful for determining the extent to which the reaction has progressed, for quality control (e.g. by analysing the reaction products and adjusting one or more parameters to encourage formation of the desired reaction product), and for determining the intermediates that are formed during a reaction.

Nanomaterials, such as carbon nanotubes, are of great interest due to their mechanical and electrical properties. The electrical properties of nanotubes, which can behave as metals or as semiconductors, depend on their morphology, in particular on their diameter and their chirality. It has been found that the electrical properties of nanotubes may be tuned by the incorporation of heteroatoms in the lattice. Boron and nitrogen are typically used, due to their similarity in atomic size with carbon and their ability to function as p-type and n-type dopants, respectively. However, it is notoriously difficult to control the synthesis of nanotubes, and in particular to achieve product uniformity on a large scale.

The details of the mechanism by which nanotubes form, and the influence of different parameters on nanotube formation, are not well understood. Typically, studies of nanotube growth rely on post-mortem studies of the products, which provide little information on the reactions taking place during nanotube formation. Consequently, it has not been possible to establish a complete growth mechanism. In situ monitoring of the growth process is therefore desirable from a point of view of providing information on the mechanism by which nanomaterials form.

In order to monitor a chemical reaction in situ, it is usually necessary to obtain, during the course of the reaction, a sample containing one or more analytes which provide information regarding the state of the reaction. However, in order for the analyte(s) to be detected, they must normally be transferred from the reaction chamber to a suitable detector. A device commonly referred to as a “transfer line” may be used for such a purpose. Capillary transfer lines are an example of such a device. However, a number of problems are associated with the use of capillary transfer lines which reduce the accuracy of the information obtained. For instance, where the reaction is conducted at high temperature, the capillary can be heated to such an extent that the sample continues to undergo reaction as it passes through the capillary. Conversely, capillary transfer lines may also be prone to rapid cooling as a result of heat exchange with the surroundings, which can result in the sample being deposited onto the tube by condensation. Moreover, when a metal device is used, the capillary can act as a catalyst, thereby affecting the composition of the sample. Flexible transfer lines made of fused silica are also known. However, such transfer lines also suffer from many of the same limitations as capillary transfer lines and, moreover, cannot be introduced into high temperature reaction chambers. For instance, many transfer lines comprise a coating which is sensitive to high temperatures and therefore cannot be introduced into high temperature reaction chambers.

Accordingly, there exists a need for a device for transferring a sample containing an analyte from a reaction chamber to a detector, which device allows a sample to be obtained at a desired location within the reaction chamber and transferred to the detector whilst substantially preserving the composition of the sample. In particular, there exists a need for a device which can be used to monitor the formation of nanomaterials in situ.

### SUMMARY OF THE INVENTION

According to an aspect of the invention, there is provided a device for transferring an analyte from a reaction chamber to a detector, which detector is capable of detecting said analyte, wherein the device comprises:
a tubular member having a first end adapted to receive a sample containing said analyte within said reaction chamber and a second end adapted to communicate with a sample inlet of said detector; and
a jacket for regulating the temperature of sample passing through the tubular member, wherein said jacket is disposed about at least a portion of the tubular member.

According to another aspect of the invention, there is provided a method of detecting an analyte present in a reaction chamber, which method comprises:
obtaining a sample containing said analyte from within said reaction chamber;
transferring at least a portion of said sample to a detector; and
detecting said analyte using said detector;
wherein said steps of obtaining and transferring are performed using a device comprising:
a tubular member through which said sample is passed from said reaction chamber to said detector, wherein said tubular member comprises a first end which receives said sample within said reaction chamber and a second end which is in communication with a sample inlet of said detector; and
a jacket which regulates the temperature of the sample passing through the tubular member, wherein said jacket is disposed about at least a portion of the tubular member.

According to a further aspect of the invention, there is provided an apparatus for detecting an analyte present in a reaction chamber, wherein the apparatus comprises a detector capable of detecting said analyte and a device for transferring said analyte from said reaction chamber to said detector, wherein the device is a device of the present invention.

A device of the present invention may be advantageous for a number of different reasons. For instance, the present device is adapted to receive a sample within the reaction chamber, and therefore may allow accurate and location-specific information regarding the inside of the reaction chamber to be obtained. In particular, a device of the present invention may be used to obtain samples from a variety of different positions within the chamber, thereby allowing the reaction chamber to be profiled and/or optimised. Moreover, a device of the present invention comprises a jacket disposed about at least a portion of the tubular member, which jacket advantageously allows the temperature of sample passing through the tubular member to be regulated. Regulating the temperature of the sample as it passes through tubular member may minimise any physical or chemical changes to the sample during transfer from the reaction chamber to the detector. For example, the device may minimise further reaction or condensation of the sample during the transfer process, or reduce the occurrence of unwanted thermal and thermocatalytic decomposition reactions (e.g. pyrolysis and cracking). Consequently, when the sample is analysed, the information obtained may provide a more accurate indication of the state of the reaction within the reaction chamber.

### DESCRIPTION OF VARIOUS EMBODIMENTS

The present invention provides a device which is suitable for transferring an analyte from a reaction chamber to a detector. A device of the present invention comprises a tubular member having a first end adapted to receive a sample containing said analyte within the reaction chamber and a second end adapted to communicate with a sample inlet of the detector. The tubular member is generally a hollow, elongate member through which the sample or a portion thereof may be transferred from the reaction chamber to the detector. The tubular member may have a variety of cross-sections, but is preferably a cylindrical member, and more preferably a right circular cylindrical member. The tubular member may be made of a flexible or a substantially rigid material. The dimensions of the tubular member may vary depending on e.g. the nature of the analyte being detected, and the type of reaction chamber and the detector being used. By way of illustration, and without limitation, the tubular member may have a length from the first end to the second end of from about 0.5 m to about 3 m, from about 0.75 m to about 1.5 m, or about 1 m; and/or may have a diameter of from about 0.2 cm to about 1 cm, about 0.4 cm to about 0.8 cm, or about 0.6 cm.

The tubular member comprises a first end which is adapted to receive a sample containing the analyte within the reaction chamber. Thus, since the first end of the tubular member will be placed within the reaction chamber during use, at least the first end of the tubular member, and preferably the entire tubular member, preferably comprises a material which is capable of withstanding the physical and chemical conditions that occur during the reaction chamber during use. The tubular member is preferably made of a material that is substantially chemically inert under the conditions of use. In this regard, the use of a material that will not catalyse a reaction of the sample and/or that is resistant to corrosive samples may be preferred. The material is preferably resistant to the extreme temperatures and/or pressures which are commonly encountered in furnaces and other high temperature reaction chambers.

In an embodiment, the tubular member is fabricated from a ceramic material (e.g. a glass) and/or a metallic material (e.g. stainless steel). The use of ceramic materials over metallic materials may be preferred particularly when the sample is susceptible to thermocatalytic decomposition, as such processes can be catalysed by metals. Preferably, the tubular member, or at least a portion of the tubular member that is to be exposed to the chamber environment, comprises a glass such as a borosilicate glass or a quartz glass. In a particularly preferred embodiment, the tubular member comprises a quartz glass. Quartz glasses can generally withstand the high temperatures and pressures that are encountered in high temperature reaction chambers. In an embodiment, the tubular member comprises a radiation resistant coating. In a particular embodiment, at least a portion of the external surface of the tubular member comprises a radiation resistant coating.

The device preferably tapers towards the first end of the tubular member. This feature may facilitate insertion of the first end of the tubular member into the reaction chamber and may allow greater control and accuracy when manipulating the device in the reaction chamber. Preferably the device is adapted to receive a sample from a variety of different locations within the reaction chamber, so that e.g. the state of a reaction at different locations within the reaction chamber can be monitored. This can be particularly advantageous for studying the level of homogeneity of products in different locations within the reaction chamber. In an embodiment, the reaction chamber comprises an elongate tubular chamber and the device is adapted to receive a sample at a plurality of different positions along the length of the chamber.

Movement of the tubular member within the reaction chamber may be controlled manually or by automation. In a particular embodiment, movement of the tubular member within the reaction chamber is controlled by automation, e.g. by robotics. Thus, for instance, the device may comprise one or more motorised units or other actuators, which allow movement of the tubular member to be controlled in one, two or three dimensions. Movement may be controlled using a suitably programmed computer.

In use, the sample may be received and passed through the tubular member by diffusion. In an embodiment, the pressure in the reaction chamber is higher than the pressure in the detector such that a pressure gradient is provided which acts as a driving force for transfer of the sample through the tubular member.

A device of the present invention may be used in conjunction with a variety of different reaction chambers. The device may be used with any chamber in which the materials are exposed to extreme temperatures. For example, the reaction chamber may be a chemical or physical vapour deposition reactor; an industrial drying, baking or roasting oven; or a refrigerator. The reaction chamber may be an analytical furnace. Particularly where the formation of carbon nanomaterials, e.g. carbon nanotubes, is desired, the reaction chamber may be a chemical vapour deposition reactor. The chamber may be of any conventional design (e.g. laboratory or industrial), and may be of any shape and size (e.g. tubular, cylindrical, spherical or cuboid). By way of illustration, and without limitation, the reaction chamber may have a length of from about 0.5 m to about 20 m, from about 0.75 m to about 10 m, or from about 1 m to about 5 m.

One of the benefits of the device of the present invention is that it may be used with a reaction chamber operating under a wide range of temperatures and a wide range of pressures. In an embodiment, the temperature within the reaction chamber is from about −100° C. to about 1500° C., e.g. from about 0° C. to about 1500° C., e.g. from about 200° C. to about 1250° C., e.g. from about 400° C. to about 1000° C. In an embodiment, the temperature within the reaction chamber is from about 400° C. to about 1500° C. In an embodiment, the temperature within the reaction chamber is from about −100° C. to about 150° C. In an embodiment, the pressure within the reaction chamber is from about 1.33×10⁻⁵ Pa to about 1.01×10⁷ Pa, from about 1.33×10⁻⁴ Pa to about 1.01×10⁶ Pa, or from about 1.33×10⁻³ Pa to about 1.01×10⁵ Pa.

One or more samples may be obtained from the reaction chamber prior to, during and/or after the reaction. The or each sample may comprise one or more components selected from e.g. reactants, intermediates and products of the reaction. The nature of the sample obtained from the reaction chamber will depend upon the reaction being monitored. Thus, the sample may comprise a solid, a liquid, a gas, or a mixture thereof. The sample may be a liquid suspension or an aerosol, in which case a filter-vaporiser extension is preferably used with the device. The sampler may collect solids as suspensions of particles, such as smoke. The sample may comprise particles having a size of less than 1 mm, less than 100 μm, less than 10 μm, less than 1 μm or less than 100 nm. The sample may comprise one or more compounds selected from organic compounds, inorganic compounds, and mixtures thereof.

The device is particularly useful for monitoring a reaction involving nanomaterials such as carbon nanomaterials which, as explained above, are difficult to monitor in situ. Thus, in a preferred embodiment, the sample comprises a nanomaterial, such as a carbon-containing nanomaterial. The carbon nanomaterial may be doped with one or more heteroatoms, such as boron or nitrogen. The nanomaterial may be a fullerene (e.g. a carbon nanotube or a spherical fullerene, e.g. a C₆₀, C₇₀, C₇₆, C₈₄, C₉₀ or C₉₄ spherical fullerene), a layered material (e.g. a two-dimensional material such as graphene), a nanowire, a nanoparticle or a nanocluster.

The tubular member also has a second end which is adapted for communication with a detector. The detector is capable of detecting one or more analytes present in the sample, and may provide useful information regarding the state of the reaction. The detector may be or may form part of an analyser, which may permit qualitative and/or quantitative analysis of the analyte(s). In an embodiment, the detector is a mass spectrometer (e.g. a tandem mass spectrometer; MS-MS), a gas chromatograph, or a mass spectrometer-gas chromatograph. Alternatively, the detector may be a gas analyser, such as a galvanic gas analyser, an industrial combustion analyser, or an emission analyser. An analyser may be used which comprises one, two or more detectors. For instance, a mass spectrometer may have one, two or more detectors for different purposes, e.g., with different detection limits and precisions. In an embodiment, the tubular member is adapted for communication with a plurality of detectors. For example, the tubular member may be a branched tubular member comprising a plurality of ends each adapted for communication with a detector. In this way, one or more samples may be obtained and passed to a number of different detectors simultaneously.

The device may comprise a capillary disposed within the tubular member, through which capillary at least a portion of the sample is introduced into the sample inlet of the detector. As a result, the build up of deposits towards the second end of the tubular member may be minimised. The capillary will generally be disposed at the second end of the tubular member and preferably extends into the tubular member. By way of illustration, the capillary may extend at least 1%, at least 3%, at least 5%, or at least 10% of the length of the tubular member as measured from the second end to the first end of the tubular member. The capillary may comprise a ceramic material (e.g. alumina, or a glass such as fused silica), a metallic material (e.g. stainless steel), or a combination thereof.

The device may comprise an adaptor for connecting said second end of the tubular member to a sample inlet of the detector. The adaptor may comprise a first end adapted for placement in or about the second end of the tubular member, and a second end which connects to a sample inlet of the detector. It may be preferable for the first end of the adaptor to be fabricated from the same or a similar material to the material from which the tubular member is fabricated. Thus, where the tubular member is fabricated from a ceramic material (e.g. a glass such as a borosilicate glass or a quartz glass), it may be preferable for the first end of the adaptor to be fabricated from a ceramic material, and more preferably from the same material as that from which the tubular member is made. The second end of the adaptor may be fabricated from the same material as the first end of the adaptor, or from a different material. In an embodiment, the first end of the adaptor is fabricated from a ceramic material (e.g. a glass such as a borosilicate glass or a quartz glass) and the second end of the adaptor is fabricated from a metallic material (e.g. stainless steel). The adaptor may be removable from the device, so that it can be easily cleaned and/or so that different adaptors can be fitted to the device depending on the type of detector being used.

The device also comprises a jacket for regulating the temperature of the sample as it passes through the tubular member, which jacket is disposed about at least a portion of the tubular member. The jacket may comprise any suitable heating or cooling means operative to regulate the temperature of sample passing through the tubular member. In an embodiment, the jacket covers at least 50%, at least 60%, at least 70%, at least 80%, at least 90%, or substantially all of the external surface area of the tubular member. The greater the proportion of the tubular member that is covered by the jacket, the more effective the jacket may be at regulating the temperature of sample passing through the tubular member.

In a preferred embodiment, the jacket comprises an inlet and an outlet for a fluid, and is adapted for fluid flow therethrough. In this case, the jacket is preferably fully sealed with respect to the tubular member so as to ensure that fluid present in the jacket does not mix with sample present in the tubular member or its surroundings. In a preferred embodiment, the fluid inlet and the fluid outlet are positioned at the same end of the jacket. Particularly where the fluid inlet and outlet protrude from the device, the inlet and outlet are preferably positioned towards the second end of the tubular member, rather towards than the first end. Such an arrangement may allow a greater proportion of the device to be inserted into the reaction chamber, and also assist with manoeuvring the device within the reaction chamber. For similar reasons, the jacket preferably tapers towards the first end of the tubular member.

The jacket may be disposed about the tubular member such that a channel is formed between an inner surface of the jacket and an outer surface of the tubular member, through which passage a fluid can be passed. The tubular member and the jacket may each be substantially cylindrical, in which case they may be arranged in a substantially concentric arrangement. In a preferred embodiment, fluid flows through at least a portion of the jacket in a counter-current relationship with sample passing through the tubular member. This may be achieved using a jacket comprising one or more internal tubular members, which partition the interior space of the jacket into two or more channels which are in fluid communication with one another. Thus, for instance, the jacket may comprise an internal tubular member which partitions the interior space of the jacket such that: an inner channel is formed between an inner surface of the internal tubular member and an outer surface of the tubular member through which the sample passes; and an outer channel is formed between an inner surface of the wall of the jacket and an outer surface of the internal tubular member. In this case, the fluid inlet and outlet of the jacket may be situated towards the second end of the transfer line, with the fluid inlet located on the inner channel and the fluid outlet located on the outer channel, and the inner and outer channels may meet towards the first end of the transfer line, the channels together forming a substantially U-shaped channel through which the fluid passes. The use of such an arrangement may enhance the insulation provided by the jacket, and thus facilitate the attainment of a constant temperature within the tubular member.

The fluid or fluids flowing through the jacket may each be a liquid or a gas. Preferred fluids may vary according to the level of temperature regulation that is required. Where the fluid is to be used at relatively low temperatures (e.g. lower than about 400° C., e.g. lower than about 300° C.), liquids may be preferred over gases due to their higher heat capacity. Water may be preferred when the fluid is to be used at a low temperature (e.g. less than about 100° C.), and where a high flow rate is required. Oils may be preferred when the fluid is at a higher temperature (e.g. between about 100° C. and about 400° C.), and when a slow flow rate is acceptable. Preferred gases include air and inert gases such as nitrogen, argon and helium. Since the efficiency of cooling or heating between inert gases does not greatly differ, the choice of gas may be based on cost and availability. In this regard, the use of helium may be preferred. The desired flow rate of the fluid may vary depending on the degree of temperature regulation that is required. By way of illustration, the fluid may flow through the jacket with a flow rate of from about 0.01 L/min to about 100 L/min, from about 0.1 L/min to about 10 L/min, or about 1 L/min.

The temperature of the fluid is selected so as to regulate the temperature of the sample as it passes through the tubular member. By way of illustration, and without limitation, the temperature of the fluid may be such that the temperature of the sample as it passes through the tubular member is from about −100° C. to about 500° C., from about 0° C. to about 400° C., or from about 100° C. to about 300° C. The temperature of the fluid in the jacket may be lower than the temperature in the reaction chamber, e.g. so as to minimise further reaction of the sample as it passes through the tubular member to the detector. For example, the temperature of the sample passing through the tubular member may be from about 50° C. to about 600° C., from about 100° C. to about 550° C., from about 150° C. to about 500° C., or from about 200° C. to about 450° C. lower than the temperature in the reaction chamber. Alternatively, the temperature of the fluid in the jacket may be higher than the temperature in the chamber, e.g. so as to minimise condensation of the sample. For example, the temperature of the fluid may be such that the temperature of the sample as it passes through the tubular member is from about 10° C. to about 500° C., from about 50° C. to about 400° C., or from about 100° C. to about 300° C. higher than the temperature in the reaction chamber. In a preferred embodiment, the temperature of the fluid is between the temperature of the reaction chamber and the temperature of the detector. For instance, where the reaction chamber is hotter than the detector, the temperature in the tubular member may be lower than that in the reaction chamber so as to minimise further reaction of the sample, yet greater than the temperature in the detector so as to minimise condensation of the sample. Similarly, where the chamber is cooler than the detector, the temperature in the tubular member may be higher than that in the reaction chamber so as to minimise condensation of the sample, yet lower than the temperature in the detector so as to minimise degradation of the sample.

Like the tubular member, the jacket is preferably fabricated from a material that is substantially chemically inert with respect to the sample under the conditions of use. In this regard, the use of a material that will not act as a catalyst for the reaction and/or that is resistant to corrosive analytes is again preferred. The jacket may be fabricated from a ceramic material (e.g. a glass) and/or a metallic material (e.g. stainless steel). Preferably, the jacket comprises a glass. In a particularly preferred embodiment, the jacket comprises a borosilicate glass or a quartz glass. In an embodiment, both the tubular member and the jacket are fabricated from a ceramic material, e.g. a glass such as a borosilicate glass or a quartz glass. The tubular member and the jacket may be fabricated as a single piece or as separate pieces. In an embodiment, the tubular member is removable from the jacket. This may allow the tubular member to be replaced with a new member or to be removed, cleaned and subsequently replaced.

Particularly at high temperatures, e.g. at temperatures greater than 500° C., radiation may be a significant route for heat transfer. Thus, in an embodiment, the jacket further comprises a radiation resistant coating. This coating may serve to prevent heating of the device by the surroundings, or to prevent heat from being lost to the surroundings. Examples of suitable materials for use in radiation resistant coatings include metallic coatings, particularly metallic coating with a high thermal stability. For instance, a preferred coating comprises platinum.

The device may comprise various other features. For instance, in one embodiment, the device further comprises an exhaust system for removing excess gas and analytes that have not entered tubular member. Alternatively or additionally, the device may further comprise a handle to assist with manoeuvring the device within the reaction chamber. In an embodiment, the device comprises means for fluid recirculation, which reclaims the fluid from the jacket, regulates its temperature and/or adjusts its flow rate, before returning the fluid to the jacket.

The present invention will now be described with reference to the accompanying drawings, in which:

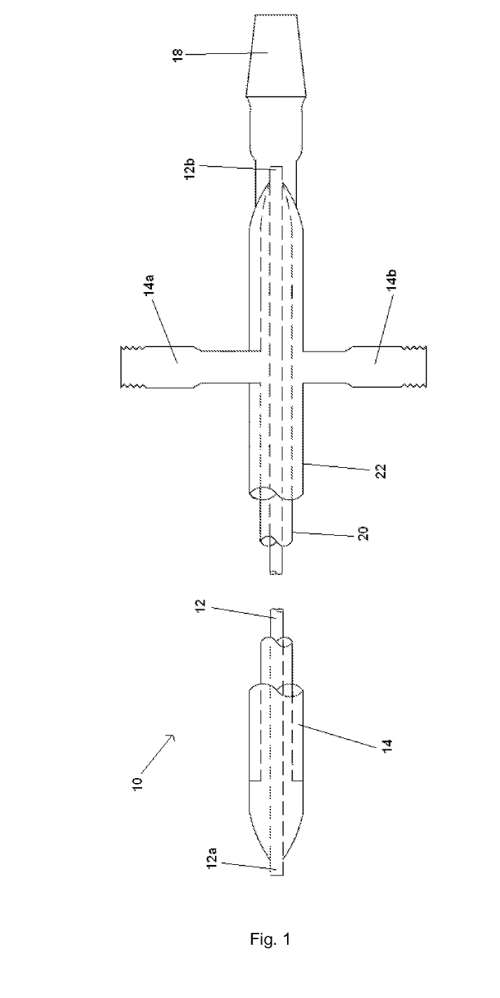

FIG. 1 is a cut-away view of a device of the present invention;

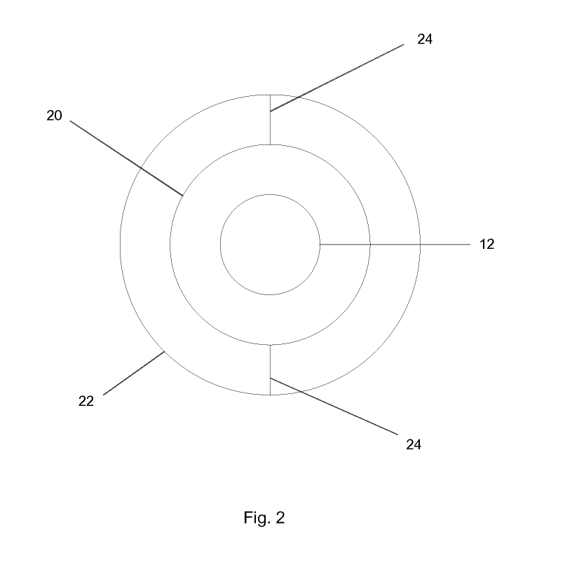

FIG. 2 depicts a cross section of the device of FIG. 1;

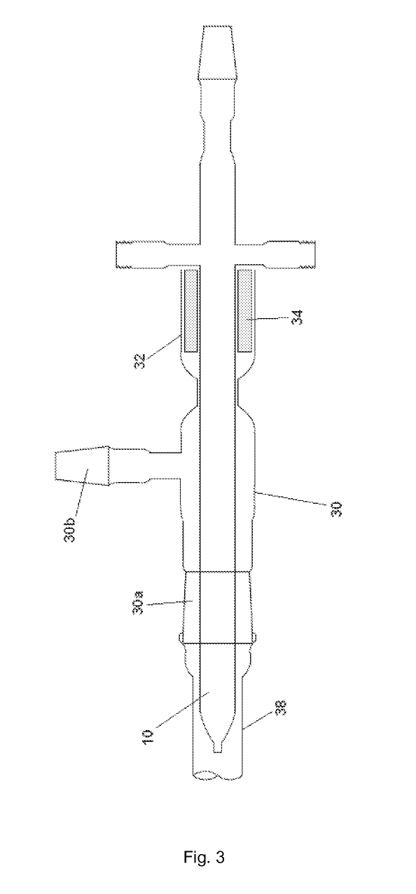

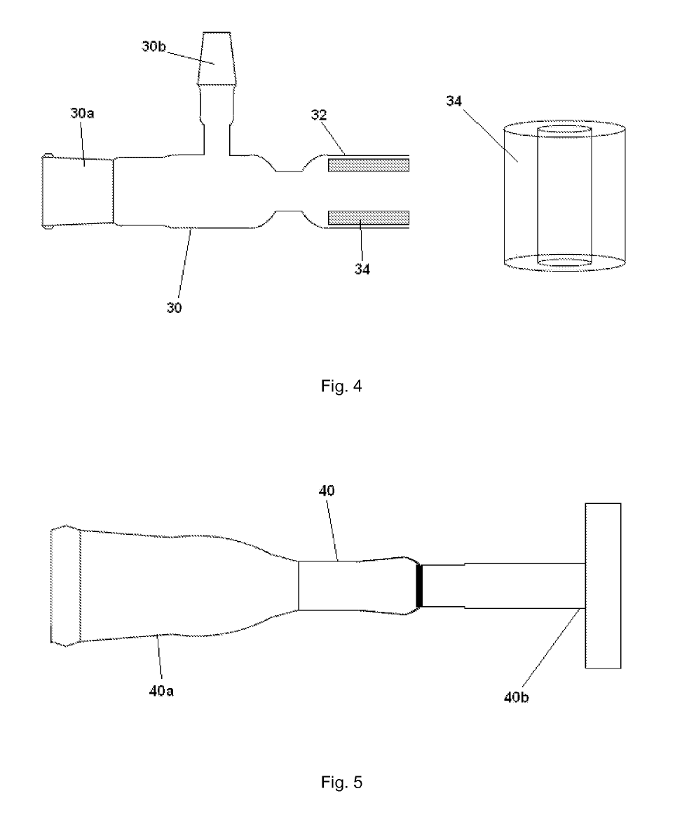

FIGS. 3 and 4 depict an exhaust system for use with the device of FIG. 1; and

FIG. 5 depicts an adaptor for connecting the device of FIG. 1 to a detector.

FIG. 1 illustrates a device in accordance with the present invention. The device 10 comprises an elongate tubular member 12 having a first end 12a and a second end 12b. A jacket 14 having a fluid inlet 14a and a fluid outlet 14b is disposed about the tubular member 12. The jacket comprises an internal tubular member 20 and an outer wall 22. The device tapers towards the first end 12a of the tubular member to assist with the introduction of the first end of the device into a reaction chamber. The device further comprises a joint 18 disposed about the second end of the tubular member 12. A cross section of the device is shown in FIG. 2, from which it can be seen that the tubular member 12, the internal tubular member 20 of the jacket, and the outer wall 22 of the jacket are arranged in a substantially concentric configuration. It can also be seen that outer wall 22 of the jacket is attached to the internal tubular member of the jacket by bridges 24.

In use, the first end 12a of tubular member is inserted within the reaction chamber (not shown) and the second end 12b is connected via joint 18 to the sample inlet of a detector (not shown). A sample containing one or more analytes of interest (e.g. a reactant, intermediate or product) is received within the reaction chamber at said first end of the tubular member. The sample may be received in the first end of the tubular member 12 by applying a pressure differential across the reaction chamber and the detector. The sample then passes from said first end 12a of the tubular member 12 to the second end 12b, and to a sample inlet of the detector. The temperature of the sample as it passes along the tubular member 12 is regulated using jacket 14, which contains a fluid (e.g. water or air) of a desired temperature. The fluid flows through the fluid inlet 14a into the channel formed between the outer surface of the tubular member 12 and the inner surface of the internal tubular member 20 of the jacket 14. The fluid flows along this channel towards the first end 12a of the tubular member 12, such that the fluid flows counter-currently to the direction of the sample passing through the tubular member 12. The fluid then flows back along the channel formed between the outer surface of the internal tubular member 20 and the inner surface of the outer wall 22 of the jacket, before exiting the jacket through fluid outlet 14b. The fluid may heat or cool the sample relative to the temperature of the reaction chamber, e.g. so as to minimise further reaction of the sample as it passes along the tubular member 12.

FIG. 3 depicts the device 10 of FIGS. 1 and 2 present in an exhaust system 30. The exhaust system may be used to remove unwanted matter, e.g. precursors, products or carrier gas from the reaction chamber, and may be particularly useful where e.g. only a small amount of analyte is required. The illustrated exhaust system 30 comprises an exhaust inlet 30a and an exhaust outlet 30b. The exhaust inlet 30a is shown engaging with reaction chamber 38. The exhaust system 30 may also serve to support the transfer device 10. As shown in FIG. 3, the exhaust system 30 has a supporting end 32 containing a supporting tube 34 in which the transfer device 10 is supported. FIG. 4 shows the exhaust system without the transfer device 10 present therein, as well as the supporting tube 34.

FIG. 5 shows an adaptor 40 for connecting the transfer device 10 shown in FIG. 1 to a detector (not shown). The adaptor comprises a first end 40a and a second end 40b. The first end 40a may be made of the same material(s) used for fabrication of the device 10 (preferably a glass, more preferably a borosilicate or a quartz glass) and is adapted to be placed about the joint 18 of the device 10. The second end 40b is adapted to connect to a sample inlet of a detector (not shown). The cone-socket configuration of the first end 40a of the adaptor 40 and the joint 18 of the device 10 helps to efficiently connect the adaptor 40 and device 10 in a sealed manner, whilst still allowing the adaptor 40 and device 10 to be separated for cleaning, replacement and/or repair.

A device of the present invention may allow for more accurate monitoring of a chemical reaction in situ. By way of illustration, a transfer device of the type shown in the Figures has been used to monitor the synthesis of multiwalled carbon nanotubes (MWCNTs) by catalytic chemical vapour deposition (CCVD). The device was used to deliver an analyte (a precursor composition) from a reaction furnace at around 800° C. for analysis in a mass spectrometer. The use of the device resulted in more accurate mass spectra with less relative abundance for peaks corresponding to the lighter hydrocarbons. Thus, the device increased the precision of the qualitative and quantitative detection of precursor composition inside the furnace.

It will be understood that the present invention has been described above purely by way of example, and modification of detail can be made within the scope of the invention. Each feature disclosed in the description, and where appropriate the claims and drawings may be provided independently or in any appropriate combination.

1. A method of detecting an analyte present in a reaction chamber, which method comprises:
obtaining a sample containing said analyte from within said reaction chamber;
transferring at least a portion of said sample to a detector; and
detecting said analyte using said detector;
wherein said steps of obtaining and transferring are performed using a device comprising:
a tubular member through which said sample is passed from said reaction chamber to said detector, wherein said tubular member comprises a first end which receives said sample within said reaction chamber and a second end which is in communication with a sample inlet of said detector; and
a jacket which regulates the temperature of the sample passing through the tubular member, wherein said jacket is disposed about at least a portion of the tubular member.

2. A method according to claim 1, wherein the sample comprises a nanomaterial.

3. A method according to claim 1, wherein the reaction chamber is a chemical or physical deposition reactor; an industrial drying, baking or roasting oven; or a refrigerator.

4. A method according to claim 1, which comprises obtaining a sample at a plurality of different positions within said reaction chamber.

5. A method according to claim 1, wherein the reaction chamber comprises a tubular chamber and the device is adapted to receive a sample at a plurality of different positions along the length of said chamber.

6. A method according to claim 1, wherein the detector is a mass spectrometer, a gas chromatograph, or a mass spectrometer-gas chromatograph.

7. A method according to claim 1, wherein the tubular member comprises a material which is substantially chemically inert with respect to the sample under the conditions of use.

8. A method according to claim 1, wherein: (i) the tubular member comprises a ceramic material; and/or (ii) the jacket comprises a ceramic material and/or a metallic material.

9. (canceled)

10. (canceled)

11. A method according to claim 8, wherein the jacket comprises an inlet and an outlet for a fluid, and is adapted for fluid flow therethrough.

12. (canceled)

13. A device for transferring an analyte from a reaction chamber to a detector, which detector is capable of detecting said analyte, wherein the device comprises:
a tubular member having a first end adapted to obtain a sample containing said analyte within said reaction chamber and a second end adapted to communicate with a sample inlet of said detector; and
a jacket for regulating the temperature of sample passing through the tubular member, wherein said jacket is disposed about at least a portion of the tubular member.

14. A device according to claim 13, wherein at least the first end of the device is adapted for insertion into a reaction chamber which is a chemical or physical deposition reactor; an industrial drying, baking or roasting oven; or a refrigerator.

15. A device according to claim 13, wherein the device is adapted to receive a sample at a plurality of different positions within the reaction chamber.

16. A device according to claim 13, wherein the device is adapted to receive a sample at a plurality of different positions along the length of an elongate tubular reaction chamber.

17. A device according to claim 13, wherein the device tapers towards said first end of the tubular member.

18. (canceled)

19. A device according to claim 13, wherein the device comprises a capillary disposed within said tubular member through which at least a portion of the sample is introduced into said sample inlet of the detector.

20. (canceled)

21. A device according to claim 13, wherein: (i) the tubular member comprises a ceramic material; and/or (ii) the jacket comprises a ceramic material and/or a metallic material.

22. (canceled)

23. A device according to claim 13, wherein the jacket comprises an inlet and an outlet for a fluid, and is adapted for fluid flow therethrough.

24. A device according to claim 23, wherein the fluid inlet and outlet are positioned towards the second end of the tubular member.

25. A device according to claim 23, wherein the jacket is disposed about at least a portion of the tubular member such that a channel is formed between an inner surface of the jacket and an outer surface of the tubular member, through which passage a fluid can be passed.

26. A device according to claim 13, wherein the jacket and/or the tubular member comprise a radiation resistant coating.

27. (canceled)

28. An apparatus for detecting an analyte present in a reaction chamber, wherein the apparatus comprises a detector capable of detecting said analyte and a device for transferring said analyte from said reaction chamber to said detector, wherein the device is a device according to claim 13.

29-35. (canceled)
